(19) United States
(12) Patent Application Publication
(10) Pub. No.: US 2009/0211100 A1
(43) Pub. Date: Aug. 27, 2009

(54) Shaving razor maintenance system

(76) Inventor: Charles D. Winsell, San Luis Obispo, CA (US)

Correspondence Address: Thomas J. Brindisi, Esq., 20 28th Place, Suite B, Venice, CA, 90291, US

(21) Appl. No.: 12/072,018

(22) Filed: Feb. 22, 2008

(51) Int. Cl. B26B 19/38; B26B 21/40

(52) U.S. Cl. 30/41; 30/538

(57) ABSTRACT

A razor maintenance system including a containment means and a two-phase liquid comprising a first, water-miscible liquid having an anti-microbial agent and a second, non-corrosive liquid that has a specific gravity less than that of the first liquid and is immiscible with the first liquid, the containment means including a razor container having a reservoir bottom and means for preventing a razor from entering the reservoir bottom and/or a sealed liquid container capable of being readily opened and preferably containing the two-phase liquid in a selected ratio along with an air gap.

### FIELD OF THE INVENTION

This invention relates to razor blade protection, and more particularly to a system for maintaining razor blades between uses.

### BACKGROUND OF THE INVENTION

A major drawback to the use of razors in shaving is their short life span. After shaving, a razor is typically set aside on a shelf or bathtub surface, with some amount of water as well as residual debris such as hair remaining on the blade. Prolonged contact with water and/or air causes the razor blade to corrode (calcify, oxidize, etc.) and/or bond with adhered debris, effectively dulling the blade and reducing its performance and life span.

Applicant's U.S. Pat. No. 5,934,459 disclosed a “Non-Corrosive Flexible Storage Pouch with Reservoir Bottom for Storing a Shaving Razor” (the contents of which are hereby incorporated by reference), which ameliorated these drawbacks significantly by separating water and debris from a razor while immersing it in a non-corrosive liquid that preferably also includes conditioner. A razor is placed in a receptacle (pouch 10) that includes a reservoir at its bottom and a support structure that holds the razor above the reservoir. The receptacle contains a water-immiscible solution (preferably oil and conditioner) that is lighter than water (and likewise typical shaving debris), so that when the razor is placed in the receptacle, water (and debris) falls off the razor and settles into the reservoir where it is separated from the razor blade and solution. Once the accumulated water and debris reaches a certain level below the stored razor (ascertainment of which is preferably aided by the receptacle being transparent or having a transparent portion), the receptacle can enjoy continued use by emptying and refilling it with new solution.

Applicant's subsequent U.S. patent application Ser. No. 09/360,008 disclosed an “Anti-Microbial Solution for Storing Razors,” which addressed the possibility of localized portions of water adhering on the blade of a razor even though suspended in a non-corrosive liquid (as in the '459 patent) by including an anti-microbial additive (e.g., a mixture of isopropyl myristate, isopropylparaben, isobutylparaben, butylparaben, BHT, and triclosan) dissolved in the non-corrosive liquid (e.g., mineral oil).

There remains a concern, however, that a user using a system according to the '459 patent and '008 application may—notwithstanding a visual indication and product instructions—continue using a receptacle after the level of accumulated water and debris has reached the razor. The razor would then be subject to corrosion to contamination by bacteria harbored in the accumulated water.

### SUMMARY OF THE INVENTION

The present invention provides a shaving razor maintenance system including a containment means and a two-phase liquid comprising a first, water-miscible liquid having an anti-microbial agent and a second, non-corrosive liquid that has a specific gravity less than that of the first liquid and is immiscible with the first liquid. The containment means includes a razor container (having a reservoir bottom and means for preventing a razor from entering the reservoir bottom, as generally known in the prior art) and/or a sealed liquid container that is capable of being readily opened and preferably contains the two-phase liquid in a selected ratio along with an air gap.

### BRIEF DESCRIPTION OF THE DRAWINGS

FIG. 1 is a front view of a razor container and a sealed liquid container containing a two-phase liquid comprising a first and second liquid.

FIG. 2 is a front view of the liquid container of FIG. 1, with the first and second liquids temporarily emulsified after shaking.

FIGS. 3 & 4 are side and top views, respectively, of the razor container of FIG. 1.

FIG. 5 is a sectional view of the razor container filled to a “fill line” with the two-phase liquid.

### DETAILED DESCRIPTION

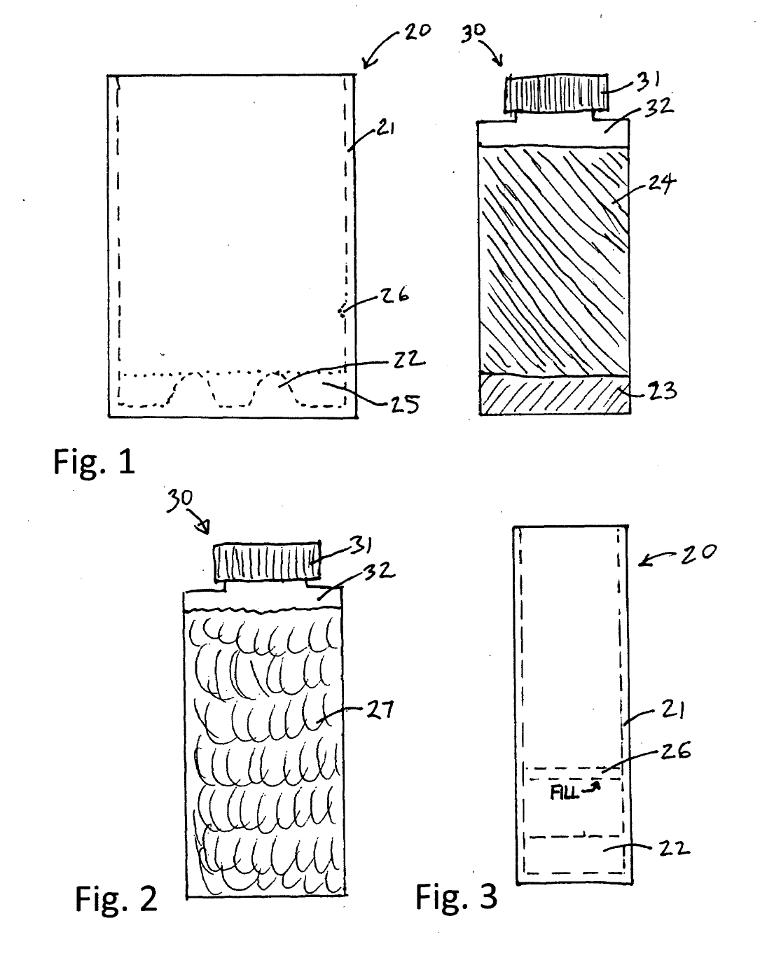

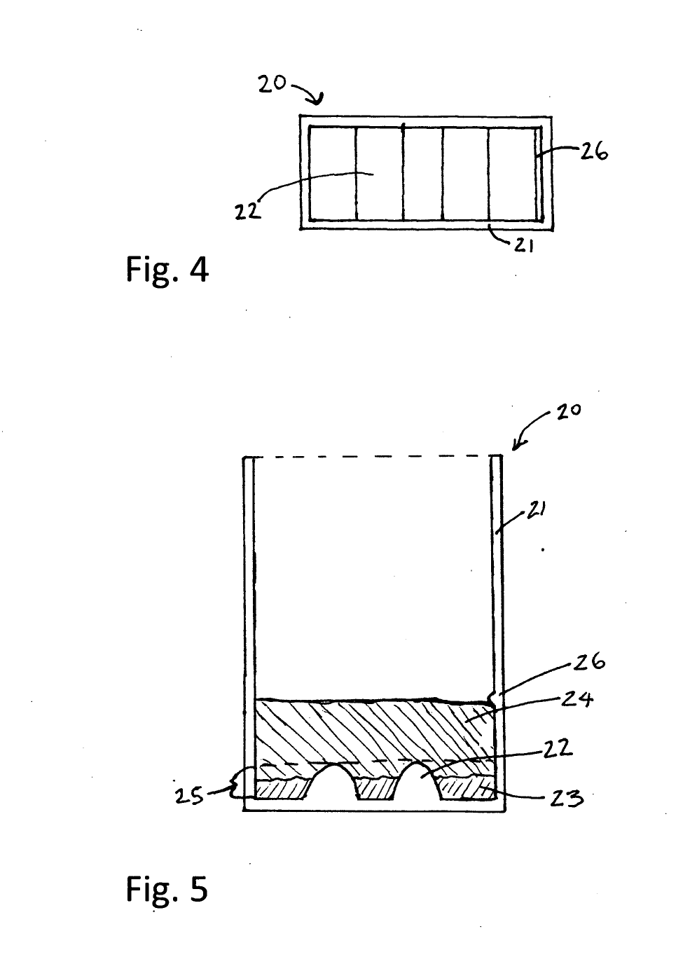

Referring FIGS. 1 and 3-5, a razor container 20 according to an embodiment of the invention has walls 21, elevated support structure 22, a reservoir bottom 25 (the vertical extent of which is indicated by the bracket in FIG. 5}, and a fill line 26. The razor container 20 may preferably be formed of a material that is stiff, such as polycarbonate. The ratio of the volume of the bottom reservoir 25 to the total volume of the razor container 20 up to fill line 26 may be in the range of 1:2 to 1:5. As shown in FIG. 1, a sealed liquid container 30 according to an embodiment of the invention (preferably a plastic bottle) has a screw-on removable plastic cap 31, and contains a two-phase liquid comprising a first liquid 23 and a second liquid 24. The first liquid 23 is water-miscible, and for example may consist primarily of water. The second liquid 24 has a specific gravity greater than the specific gravity of the first liquid 23, and is immiscible with the second liquid 24. For example, the second liquid 24 may consist of white mineral oil (petrolatum) or a suitable silicone oil. One or both of the first liquid 23 and second liquid 24 may optionally include suitably-soluble colorants to facilitate visual distinction of the liquids from one another. The first liquid 23 includes a water-miscible anti-microbial agent such as Dowicil® 200, preferably in a relatively high concentration such as 0.1% (so that when run-off water accumulates in first liquid 23 as explained below, the anti-microbial is not diluted below a minimum level of desired efficacy). The second liquid 24 may also include skin-friendly additives and/or an anti-microbial agent, such as described in Applicant's U.S. patent application Ser. No. 09/360,008, the contents of which in that regard are hereby incorporated by reference.

The liquid container 30 is partially filled with the two liquids, with the ratio of the first liquid 23 to the total liquid volume preferably being relatively small, e.g., 1:4 to 1:12. Upon manual shaking (the turbulence of which is enhanced by the provision of air gap 32), the two liquids readily form an emulsion 27 as shown in FIG. 2, which then dissipates relatively rapidly. In use, a user manually shakes a liquid container 30 containing the two-phase liquid to emulsify the two liquids, which ensures that the aforementioned ratio of first liquid 23 to total liquid attains throughout the liquid on a fine scale. The user then pours a portion of the temporarily emulsified liquid into an empty razor container 20, until the liquid reaches the fill line 26. After a period of time, the liquid settles back into two phases (resuming the aforementioned ratio on a gross scale), with the first liquid 23 residing entirely within the reservoir bottom 25, and the second liquid 24 being entirely above the first liquid 23 although partly within the top of reservoir bottom 25. The user can then place a shaving razor (not shown) into the razor container 20, with the handle end up and the head end down and resting on the tops of elevated support structure 22. Water and debris clinging to the razor will then tend to fall off of the razor (due to its greater density than the second liquid 24) and settle at the bottom of reservoir bottom 25. Since the first liquid 23 at the bottom of reservoir bottom 25 is water-miscible, settling water will mix with and become incorporated into first liquid 23. And since first liquid 23 includes an anti-microbial agent, even if a user allows the first liquid 23 and residue to accumulate above the top of elevated support structure 22 so as to come into contact with the razor, the razor will not be exposed to bacteria.

While the invention is susceptible to various modifications and alternative forms, specific examples have been shown in the drawings and as described in detail. It should be understood, however, that the invention is not limited to the particular forms disclosed. Rather, the invention is intended to cover all modifications and alternatives falling within the spirit and scope of the claims and their equivalents.

What is claimed is:

1. A shaving razor maintenance system comprising:
a. a containment means;
b. a two-phase liquid that comprises:
i. a first liquid including a first anti-microbial agent; and
ii. a second liquid that is non-corrosive;
wherein said first liquid is water-miscible and has a specific gravity that is greater than the specific gravity of said second liquid, and said first liquid is immiscible with said second liquid.

2. The system of claim 1, wherein said first liquid is a different color than said second liquid.

3. The system of claim 1 wherein said containment means includes a sealed liquid container that is capable of being readily opened.

4. The system of claim 3, wherein said first liquid and said second liquid are capable of existing together temporarily in emulsion.

5. The system of claim 4, wherein said liquid container is partially filled with said two-phase liquid so as to leave a substantial air gap.

6. The system of claim 4, wherein said second liquid includes a second anti-microbial agent.

7. The system of claim 1, wherein said containment means includes a razor container.

8. The system of claim 7, wherein said razor container has a reservoir bottom, and includes means for preventing razors intended for use with said razor container from entering said reservoir bottom.

9. The system of claim 8, wherein said means for preventing includes one or more elements protruding upwardly from said reservoir bottom.

10. The system of claim 8, wherein said razor container has a visually-demarcated “fill line.”

11. The system of claim 1 wherein said containment means includes a razor container and a sealed liquid container that is capable of being readily opened.

12. The system of claim 11, wherein said razor container has a reservoir bottom, and includes means for preventing razors intended for use with said razor container from entering said reservoir bottom.

13. The system of claim 12, wherein said razor container has a visually-demarcated “fill line.”

14. The system of claim 13, wherein said first liquid and said second liquid are capable of existing together temporarily in emulsion, and wherein said liquid container is partially filled with said two-phase liquid so as to leave a substantial air gap.

15. The system of claim 14, wherein the ratio of the volume of said reservoir to the volume of said razor container up to said “fill line” exceeds the ratio of the volume of said first liquid within said liquid container to the volume of said two-phase liquid within said liquid container.

16. The system of claim 15, wherein the ratio of the volume of said first liquid within said liquid container to the volume of said two-phase liquid within said liquid container is less than 1:4.

17. The system of claim 16, wherein the ratio of the volume of said reservoir to the volume of said razor container up to said “fill line” is less than 1:2.

18. A razor container for use in a razor maintenance system that includes a two-phase liquid comprising a first liquid that is water-miscible and has an anti-microbial agent and a second liquid that is non-corrosive and has a specific gravity that is lower than the specific gravity of said first liquid and is immiscible with said first liquid, the razor container including a reservoir bottom, and means for preventing razors intended for use with said razor container from entering said reservoir bottom.

19. The razor container of claim 18, wherein at least part of the razor container is transparent, and wherein the razor container includes a visually-demarcated “fill line.”

20. The razor container of claim 19, wherein the razor container is partly filled with the two-phase liquid, with the first liquid being below the “fill line.”
